(19) United States
(12) Patent Application Publication
(10) Pub. No.: US 2009/0070472 A1
(43) Pub. Date: Mar. 12, 2009

(54) AUTOMATIC AND SECURE CONFIGURATION OF WIRELESS MEDICAL NETWORKS

(75) Inventors: Heribert Baldus, Aachen (DE); Karin Klabunde, Bochum (DE); Francesco Gallo, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/160,892

(22) PCT Filed: Jan. 8, 2007
(86) PCT No.: PCT/US2007/060204

§ 371 Date: Jul. 15, 2008

Related U.S. Application Data
(60) Provisional application No. 60/760,020, filed on Jan. 18, 2006.

(51) Int. Cl. G06F 15/16; G06F 21/00

(52) U.S. Cl. 709/227; 726/3

(57) ABSTRACT

A system (10) automatically configures and sets up an ad hoc wireless medical network (40). Wireless peer devices (22₁, 22₂, . . . , 22ₙ) each includes a peer BCC interface module (24₁, 24₂, . . . , 24ₙ) for authenticating a patient and transmitting device identification of a selected peer device (22₁, 22₂, . . . , 22ₙ), and a short-range network interface module (30₁, 30₂, . . . , 30ₙ) for setting up communication connection between the peer devices (22₁, 22₂, . . . , 22ₙ). An active identification device (28), which is linked to the patient (14), authenticates each selected peer device (22₁, 22₂, . . . , 22ₙ) and automatically associates each selected peer device (22₁, 22₂, . . . , 22ₙ) with the patient (14). A patient BCC interface module (36), coupled with the patient (14), transmits network parameters from the active identification device (28) to the peer devices (22₁, 22₂, . . . , 22ₙ).

The following relates to the network systems and methods. It finds particular application in conjunction with short-range medical wireless network systems and will be described with particular reference thereto. However, it is to be appreciated that the following will also find application in conjunction with other network systems and the like.

Short-range wireless systems typically have a range of less than one hundred meters, but may connect to the Internet to provide communication over longer distances. Short-range wireless systems include, but are not limited to, a wireless personal area network (PAN) and a wireless local area network (LAN). A wireless PAN uses low-cost, low-power wireless devices that have a typical range of about ten meters. An example of a wireless PAN technology is the IEEE 802.15.1 Bluetooth Standard. An example of a wireless LAN technology is the IEEE 802.11x Wireless LAN Standards.

Typical short-range network devices include, but are not limited to, mobile telephones, personal or laptop computers, and personal electronic devices such as personal digital assistants (PDA), pagers, portable-computing devices, or medical devices. Each Bluetooth device includes application and operating system programs including service discovery protocols which are designed to discover other Bluetooth devices (i.e. peer devices) as they enter or leave the communication range of the Bluetooth device. Devices can dynamically join or leave a Bluetooth network.

Personal Healthcare systems are increasingly using wireless communication. Typically, wireless medical sensors and devices are used to obtain, process or display telemetric data of the patient such as patient's weight, blood pressure, vital functions, and the like. The wireless medical sensors and devices use radio links for communication and transmission of data to other devices within the network or external care providers. For example, the monitoring systems typically include several devices (such as sensors, measurement devices, displays, servers, communication devices which connect to external medical services) which have to communicate with each other to provide the desired service.

Setting up such a wireless system is a difficult task. Manual configuration is time-consuming and requires complex interactions and detailed knowledge of communication systems and networking. The user, for example, has to configure network type, network name, network addresses and security parameters (e.g. PINs) for all involved devices. While professionals are typically available to set up and maintain commercial networks in hospitals and health care facilities, this support is not necessarily available for home networks. When it is available, the costs are high. Manual configuration and set up are often not feasible by the patients, as many patients are elderly people who are not technologically literate.

In addition, when a non-expert user controls the network set up and configuration, an unauthorized user might connect to the devices and make possible the misuse of the system.

Other solutions use semi-automatic configuration and setup of the wireless communication system. The semi-automatic solutions require additional dedicated setup devices, similar to the manual setup solution, and are complex to use.

The present application provides new and improved apparatuses and methods which overcome the above-referenced problems and others.

In accordance with one aspect, a system for automatic configuration and set up of an ad hoc wireless medical network is disclosed. Wireless peer devices each includes a BCC interface module for authenticating a patient and transmitting the device identification of a selected peer device, and a short-range network interface module for setting up communication connection between the peer devices. An active identification device, which is linked to the patient, authenticates each selected peer device and automatically associates each selected peer device with the patient. A patient BCC interface module is coupled with the patient and transmits network parameters from the active identification device to the peer devices.

In accordance with another aspect, an adapter for wirelessly interconnecting peer devices, which each includes a short-range wireless interface unit, is disclosed. A first portion is coupled to a person and includes a person BCC interface for transmitting person identification and network configuration parameters via a person body. A second portion is associated with each individual peer device and respective short-range wireless interface unit, and includes a peer BCC interface for transmitting device identification via the person body when the person and a selected peer device are temporarily coupled.

In accordance with another aspect, a method is disclosed. A BCC interface, connected to a patient, is temporarily linked to BCC interface modules connected to first and second peer devices. The first and second peer devices are automatically connected into a wireless network in response to the first and second peer devices being linked to the patient BCC interface.

Still further advantages and benefits of the present application will become apparent to those of ordinary skill in the art upon reading and understanding the following detailed description of the preferred embodiments.

The application may take form in various components and arrangements of components, and in various steps and arrangements of steps. The drawings are only for purposes of illustrating the preferred embodiments and are not to be construed as limiting the application.

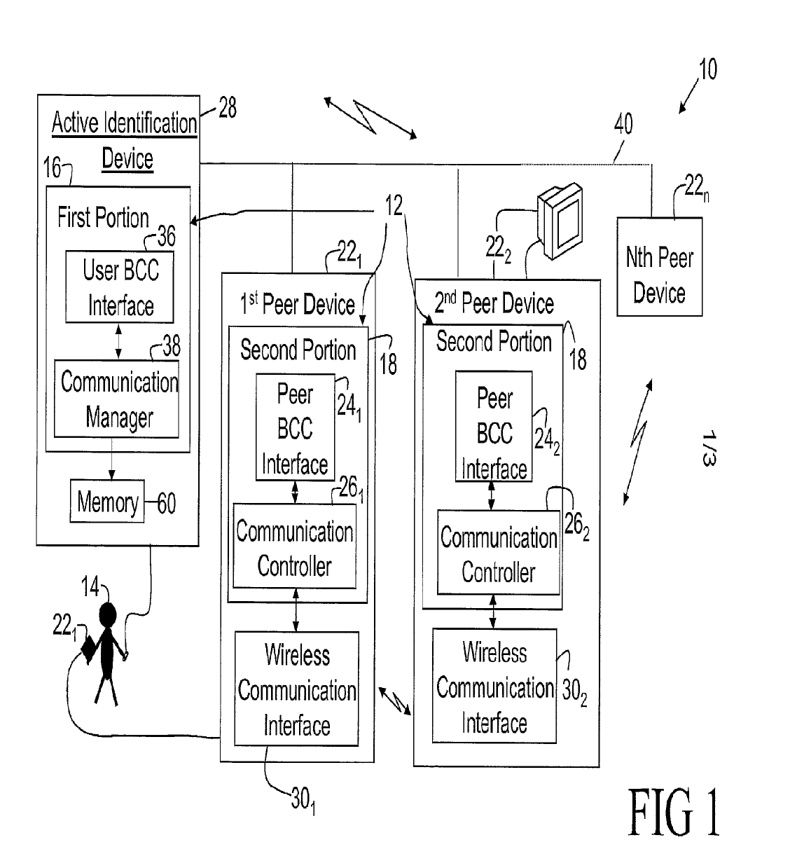

FIG. 1 is a diagrammatic illustration of an identification system;

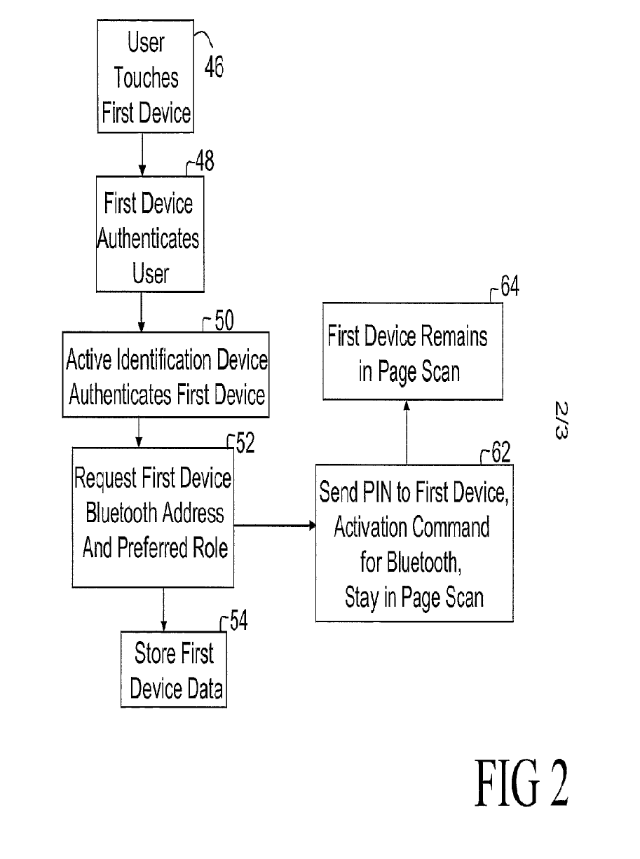

FIG. 2 shows a process flow of the identification system;

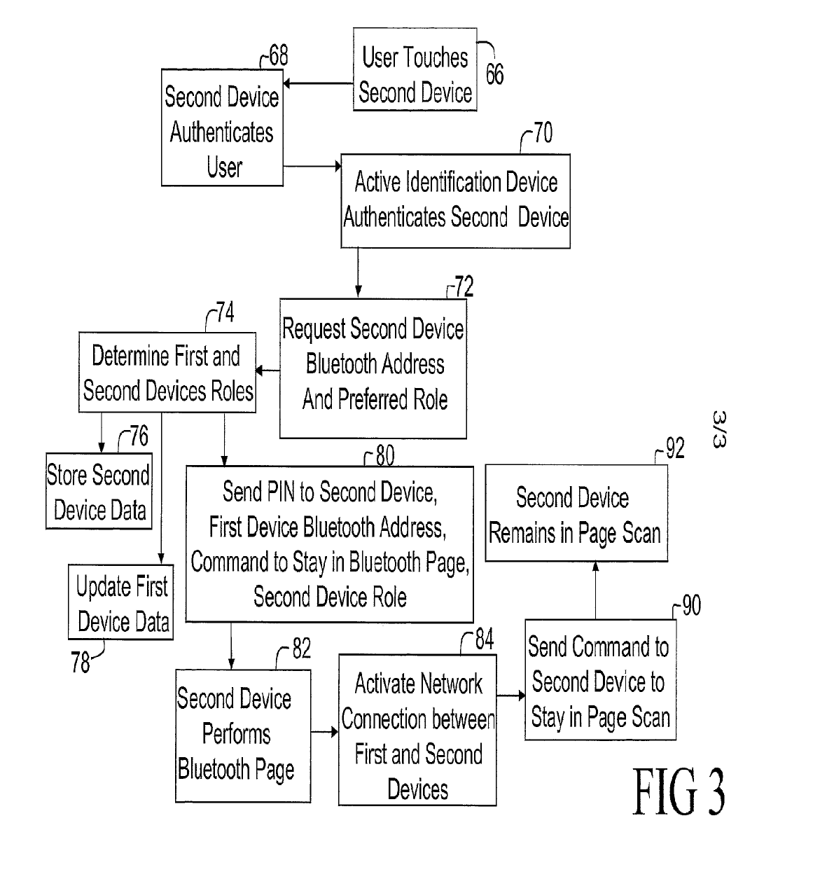

FIG. 3 shows a process flow of the second identification system.

With reference to FIG. 1, a medical system 10 includes a network adapter 12 which associates various devices with a user or patient 14 and configures the associated devices into a network. The network adapter 12 includes a first portion 16 which is linked to the patient 14 and a second portion 18 which is included with each of first, second, . . . , n^{th} peer devices 22₁, 22₂, . . . , 22ₙ such as wireless medical devices, communication devices, and the like.

The examples of the peer devices include a sensor node 22₁ disposed on the patient 14 to monitor vital signs such as electrocardiographic (ECG) data, heart rate, respiratory rate, respiratory cycle, blood pressure, or so forth; and a communication device, such as an illustrated home television set 22₂, a remote control, a VCR, a cable box, a computer, and the like. The illustrated devices are examples, and those skilled in the art can readily include additional or other devices such as high resolution sensors, bedside monitors, ventilators, and the like that can be coupled into the network. Moreover, the devices can be arranged into the network on an ad hoc basis by adding or removing medical or communication devices.

Each second portion 18 includes a first or peer body coupled communication (BCC) interface device or module or unit 24₁, 24₂, . . . , 24ₙ capable of wireless communication via near-field body-communication technology, which is based on capacitive coupling to the patient 14, a communication controller 26₁, 26₂, . . . , 26ₙ for establishing wireless communications with a patient's active identification device or means or module 28, as described below, and controlling a wireless short-range communication interface device or module or unit 30₁, 30₂, . . . , 30ₙ such as a Bluetooth communication interface for establishing wireless communications between the peer devices. A description of the Bluetooth communication protocol and device operation principles is found, for example, in Bluetooth Special Interest Group, Specification of the Bluetooth Standard, version 1.0B, volumes 1 and 2, December 1999 and Bluetooth Specification, Version 2.0, November 2004. Of course, it is contemplated that the peer device can use other short-range technologies such as IEEE 802.15.4 ZigBee, 802.11 WLAN and the like short-range communication technologies. Each Bluetooth interface device 30₁, 30₂, . . . , 30ₙ includes application and operating system programs designed to find other Bluetooth devices as the other devices enter and leave the communication range of the network.

The active identification device or means or module 28 is attached to or associated with the patient or user or patient's body 14 as a band at a wrist, leg, built into a watch, an ID card, or the like. Alternatively, the active identification device 28 is a non-contact device and is disposed in a close proximity, e.g. within 10 cm, of the patient's body 14. The active identification device 28 utilizes a near-field body-communication technology to communicate with the peer devices 22₁, 22₂, . . . , 22ₙ, when the patient 14 is coupled to a selected peer device. The active identification device 28 includes a body coupled second or patient or user communication (BCC) interface 36 and a communication manager 38. As described in detail below, when the user 14 touches, for example, at least one of the first and second devices 22₁, 22₂, the communication controllers 26₁, 26₂ of each touched device 22₁, 22₂ and the active identification device communication manager 38 communicate with each other via the peer BCC interface devices 24₁, 24₂ and patient BCC interface device 36. After verifying the user's authorization, the first and second devices 22₁, 22₂ send the corresponding device data to the active identification device 28, after which the network configuration parameters are received by the touched first and second peer devices 22₁, 22₂ from the active identification device 28. The communication controllers 26₁, 26₂ and wireless communication interface modules 30₁, 30₂ of each first and second peer device 22₁, 22₂ are activated and initiate establishing a wireless ad-hoc network 40. After the network 40 is established, the application data is exchanged among the first and second peer devices 22₁, 22₂, e.g. the network members. A third or additional wireless device can join an existing established wireless network 40 when the user 14 touches the n^{th} device (not shown) and any device belonging to the established network 40 such as the first and second peer devices 22₁, 22₂ of the example above.

With continuing reference to FIG. 1 and further reference to FIG. 2, the user 14 touches 46 the first device 22₁. The active identification device communication manager 38 communicates with the first device communication controller 26₁ via body coupled communications. The first device 22₁ authenticates 48 the active identification device 28 and the user, e.g. the first device 22₁ reads the patient's identification to avoid usage by unauthorized users. The active identification device 28 authenticates 50 the first device 22₁ via body coupled communications. After successful mutual authentication, the active identification device communication manager 38 requests 52 the first device 22₁ to transmit a first device Bluetooth Address and Preferred Bluetooth Role such as master, slave or both. The first device data is stored 54 in an active identification device memory 60 for a fixed period of Bluetooth data timeout time Tₒᵤₜ. The active identification device communication controller 38 sends 62 to the first device communication controller 26₁ a pin number (PIN) to be used during the network connection establishment, a command message to activate the first peer device Bluetooth interface 28₁, and a command for the first device 22₁ to remain 64 in a page scan mode for a page scan duration time T_{pg}_{_{—}}_{scan}.

With continuing reference to FIG. 1 and further reference to FIG. 3, to connect the second device 22₂ into the network 40, the user 14 touches 66 the second device 22₂. The active identification device communication manager 38 communicates with the second device communication controller 26₂ via body coupled communications. The second device 22₂ authenticates 68 the active identification device 28 and the user to avoid usage by unauthorized users. The active identification device 28 authenticates 70 the second device 22₂. After successful mutual authentication, the active identification device communication manager 38 requests 72 the second device communication controller 26₂ to transmit a second device Bluetooth Address and Preferred Bluetooth Role such as master, slave or both. The active identification device communication controller 38 determines 74 which of the first and second devices 22₁, 22₂ is the master of the network 40, e.g. the network roles are assigned to the first and second devices. The data of the second device 22₂, including at least its role as a master or a slave, is stored 76 in the active identification device memory 60 for a fixed period of Bluetooth data timeout time Tₒᵤₜ. The device role, e.g. master or slave, of the first device 22₁ is updated 78 in the active identification device memory 60 if required. It is important to keep the data of the master of the connection—at least this data needs to be stored in the active identification device memory 60.

The active identification device communication manager 38 sends 80 to the second device communication controller 26₂ a command message to perform a Bluetooth page to the first device 22₁. More specifically, the active identification device 28 sends 80 the second device communication controller 26₂ a message including the first device Bluetooth address, pin number PIN, a Bluetooth page duration time T_{pg} and the second device network role such as a master or a slave. The second device wireless interface 30₂ performs 82 the Bluetooth page while the first device wireless interface 30₁ is in the page scan mode, i.e. the Bluetooth interface connection set up between the first and second devices 22₁, 22₂ is activated 84. This results in a network connection establishment between the first and second devices for a first-second devices connection establishment duration time T_{D1-D2}.

The active identification device communication controller 38 sends 90 to the second device 22₂ a request to stay in the page scan mode after the connection between the first and second devices 22₁, 22₂ has been established. The second device 22₂ remains 92 in the page scan mode for a time equal to the difference between the Bluetooth data timeout Tₒᵤₜ and the first-second devices connection establishment duration time T_{D1-D2}.

Of course, it is also contemplated that the user 14 can touch the first and second peer devices 22₁, 22₂ at the same time to initiate interconnection of the first and second devices 22₁, 22₂ into the network 40.

If the Bluetooth data timeout time Tₒᵤₜ of the active identification device 28 times out, the data of the first and second devices 22₁, 22₂ is deleted. The connection of the two devices remains unless terminated by other actions or control software on the devices.

To connect the third device (not shown) into the established network 40 between the first and second devices 22₁, 22₂, the user 14 touches the third device. The following situations are distinguished:

(a) The second device 22₂ is in the page scan mode: The user touches the third device. The connection is established similar to the establishment of the second device connection described above.

(b) The second device 22₂ is in the page scan mode: The connection can be established by the user touching the network member, and subsequently the third device.

(c) The second device 22₂ page scan duration time T_{pg}_{_{—}}_{scan} is expired: The connection can be established by the user touching the third device, and subsequently the network member 22₁ or 22₂.

(d) The second device page scan duration time T_{pg}_{_{—}}_{scan} is expired: The connection can be established by the user touching the network member 22₁ or 22₂, and subsequently the third device.

The system takes into account whether the touched network member is the master or one of the slaves and whether the network supports scatternets or not.

The Bluetooth page time T_{pg} and page scan time T_{pg}_{_{—}}_{scan} scale are the timeouts for the devices performing Bluetooth Page or Bluetooth Page Scan, respectively. During the procedure to connect two devices that are not connected to any network, the Bluetooth page time T_{pg} and page scan time T_{pg-scan} can be different due to some delays on the body coupled communication. The active identification device 28 is aware of the introduced delay, e.g. using an internal clock, and modifies accordingly the Bluetooth page time T_{pg} and page scan time T_{pg}_{_{—}}_{scan} in the command message sent to the devices. If the active identification device 28 determines that there is no delay, the active identification device 28 sets the Bluetooth page time T_{pg} to be equal to the page scan time T_{pg}_{_{—}}_{scan}. The active identification device 28 sets the values of the Bluetooth page time T_{pg} and page scan time T_{pg}_{_{—}}_{scan} according to the application. For example, a value of the Bluetooth data timeout Tₒᵤₜ is selected to be from about 10 seconds to about 60 seconds. In one embodiment, the value of the Bluetooth data timeout Tₒᵤₜ is greater than or equal to the Bluetooth page time T_{pg}. In one embodiment, the equal value such as 10 seconds for the Bluetooth data timeout Tₒᵤₜ, the Bluetooth page time T_{pg} and page scan time T_{pg}_{_{—}}_{scan} is selected. E.g., it is assumed it takes about 10 seconds to touch two devices sequentially.

In this manner, intuitive automatic and secure configuration and set-up of wireless networks is accomplished where devices are connected when the user touches the devices simultaneously or subsequently. By mutual authentication between each of the devices 22₁, 22₂, . . . , 22ₙ and the active identification device 28 worn by the user 14, who is touching the devices to be connected, the connection set-up is limited to authorized persons only. The identified user can connect only to the devices particularly designated for use by the identified user when he/she touches the devices.

As another example, using Bluetooth discovery directly, the user might discover the available devices. The user then selects from a list of all found devices. In this case all devices being in Bluetooth range would be discovered. (This is not really a user friendly solution.)

In the manner described above, the active identification unit is used as a middleman for storage and transmission of necessary information to set up a network connection. As the BCC interface needs less power as compared to the Bluetooth interface, using BCC interface for connection set up saves power compared to using mechanisms of Bluetooth directly as the Bluetooth interface can sleep until needed.

The method and apparatus described above can be applied in all domains where wireless ad hoc networks are being deployed and to all types of wireless technologies such as Bluetooth, WLAN (IEEE 802.11), ZigBee (IEEE 802.15.4) and the like. The application areas include: (a) Easy and secure set-up of wireless networks for Personal Area Networks as in PHC, including user-specific configuration of devices; (b) Association of body-worn devices with peripheral devices, for example ECG sensor and bedside monitor for home monitoring of vital signs, integration of wireless scale to body area network for personal healthcare applications; and (c) Application in consumer-related application, allowing easy integration of home monitoring functionality into in-home networks.

It is also contemplated that some devices, particularly communication devices, can be on more than one local network. In this manner, two patients in the same household can communicate their medical information to a central location with the same communication device.

The above has been described with reference to the preferred embodiments. Modifications and alterations may occur to others upon a reading and understanding of the preceding detailed description. It is intended that the application be constructed as including all such modifications and alterations insofar as they come within the scope of the appended claims or the equivalents thereof.

1. A system for automatic configuration and set up of an ad hoc wireless medical network comprising:
wireless peer devices which each includes:
a peer BCC interface module for authenticating a patient and transmitting device identification of a selected peer device, and
a short-range network interface module for setting up communication connection between the peer devices; and
an active identification device, linked to the patient, which active identification device authenticates each selected peer device and automatically associates each selected peer device with the patient, the active identification device including:
a patient BCC interface nodule, coupled with the patient, for transmitting network parameters from the active identification device to the peer devices.

2. The system as set forth in claim 1, wherein the patient BCC interface module communicates patient identification via a patient body to the peer BCC interface module of each selected peer device and receives the device identification from each selected peer BCC interface module via the patient body when the patient BCC interface is temporarily coupled to the selected peer BCC interface module.

3. The system as set forth in claim 2, wherein the active identification device further includes:
a communication manager which automatically associates the transmitted device identification with the patient identification and assigns network configuration parameters to each selected peer device to configure the selected peer devices into the network.

4. The system as set forth in claim 3, wherein each peer device further includes:
a communication controller which transmits the device identification to the communication manager and receives the network configuration parameters from the communication manager, the communication controller and communication manager communicate with one another via the selected peer BCC interface module and patient BCC interface module.

5. The system as set forth in claim 4, wherein the communication manager configures the short-range network interface modules of the selected peer devices to establish network connection between the selected peer devices.

6. The method as set forth in claim 5, wherein the first and second short-range interface modules include at least one of:
Bluetooth interface;
Zig-Bee interface; and
WLAN interface.

7. The system as set forth in claim 3, wherein the active identification device further includes:
a memory which stores the transmitted device identification and assigned network parameters of the selected peer devices for a data timeout time.

8. The system as set forth in claim 7, wherein the communication manager automatically dissociates the selected peer devices from the patient when the data timeout time expires.

9. A wireless peer device for use on the system of claim 1, the wireless peer device including:
a communication controller which transmits the device identification to the communication manager and receives the network configuration parameters from the communication manager, the communication controller and communication manager communicate with one another via a patient body.

10. An adapter for wirelessly interconnecting peer devices, which each includes a short-range wireless interface unit, the adapter comprising:
a first portion coupled to a person and including a person BCC interface for transmitting person identification and network configuration parameters via a person body; and
a second portion associated with each individual peer device and respective short-range wireless interface unit which second portion includes a peer BCC interface for transmitting device identification via the person body when the person Hand a selected peer device are temporarily coupled.

11. The adapter as set forth in claim 10, wherein the second portion further includes:
a communication controller which transmits the device identification of the selected peer device to the first portion via a respective peer BCC interface.

12. The adapter as set forth in claim 11, wherein the first portion further includes:
a communication manager which automatically associates the transmitted device identification with the person identification and transmits the network configuration parameters to a communication controller of the selected peer device to interconnect the short-range wireless interface unit of each selected peer device so that the selected peer devices form the network.

13. The adapter as set forth in claim 12, wherein the short-range interface units include at least one of:
Bluetooth interface;
Zig-Bee interface; and
WLAN interface.

14. A method comprising:
temporarily linking a BCC interface, connected to a patient, to BCC interface nodules connected to first and second peer devices; and
automatically connecting the first and second peer devices into a wireless network in response to the first and second peer devices being linked to the patient BCC interface.

15. The method as set forth in claim 14, wherein the step of connecting includes:
receiving patient identification via a patient body at the first device;
receiving device identification of the first peer device via the patient body at the patient BCC interface; and
associating the first peer device identification with the patient identification.

16. The method as set forth in claim 15, wherein the step of connecting further includes:
transmitting network configuration parameters to the first peer device; and
activating a first short-range network interface module on the first peer device.

17. The method as set forth in claim 16, further including:
receiving patient identification via the patient body at the second device;
receiving device identification of the second peer device via the patient body at the patient BCC interface;
associating the second peer device with the patient identification;
transmitting network configuration parameters to the second peer device; and
activating a second short-range network interface module on the second peer device.

18. The method as set forth in claim 17, further including:
connecting an n^{th} peer device into the wireless network by one of:
(a) temporarily linking the patient BCC interface to a BCC interface module connected to the n^{th} peer device, and
(b) temporarily linking the patient BCC interface to the BCC interface module connected to the n^{th} peer device and one of the first and second devices connected into the wireless network.

19. The method as set forth in claim 17, wherein the step of linking includes one of:
contemporaneously linking the patient BCC interface to the BCC interface modules connected to the first and second peer devices, and
linking the patient BCC interface to the BCC interface module connected to the second peer device subsequent to linking the patient BCC interface to the BCC interface module connected to the first peer device.

20. An active identification device for automatically connecting the first and second peer devices into the wireless network as set forth in claim 16.
